(19) United States
(12) Patent Application Publication
(10) Pub. No.: US 2017/0182592 A1
(43) Pub. Date: Jun. 29, 2017

(54) SYSTEMS AND METHODS FOR WELDING WORKPIECES USING A LASER BEAM AND OPTICAL REFLECTORS

(71) Applicants: BAXTER INTERNATIONAL INC., Deerfield, IL (US); BAXTER HEALTHCARE S.A., Glattpark ( Opfikon) (CH)

(72) Inventors: Alexander SAVITSKI, Libertyville, IL (US); Mark Timothy FOOTE, Lakemoore, IL (US); Lewis E. Daniels, Jr., Wonderlake, IL (US); Yuanpang Samuel DING, Long Grove, IL (US); Anthony J. REISCHE, Mount Prospect, IL (US)

(21) Appl. No.: 15/304,835

(22) PCT Filed: Apr. 16, 2015
(86) PCT No.: PCT/US2015/026180

§ 371 Date: Oct. 17, 2016

Related U.S. Application Data
(60) Provisional application No. 61/980,985, filed on Apr. 17, 2014.

(51) Int. Cl. B23K 26/10; B23K 26/08; B23K 26/282; B23K 26/06

(52) U.S. Cl. CPC B23K 26/103; B23K 26/0643; B23K 26/0869; B23K 26/282; B23K 2201/06

(57) ABSTRACT

A laser device is provided for performing an annular circumferential welding on a workpiece, and includes a laser head having a laser source configured for emitting a laser beam to perform welding around an outer circumferential target area of the workpiece. Also included is an optical reflector assembly having at least two optical reflectors spaced from the workpiece for reflecting the laser beam emitted from the laser head. The reflectors are spaced from each other, disposed on opposite lateral sides of the workpiece, and inclined relative to an axis transverse to a longitudinal axis of the workpiece so that the circumferential weld is achieved by a single cycle of the laser beam.

### CROSS-REFERENCE

This application claims priority of U.S. Provisional Application Ser. No. 61/980,985, filed Apr. 17, 2014 under 35 U.S.C. §119(e), which is incorporated herein by reference, and PCT/US2015/026180 filed Apr. 16, 2015, under 35 U.S.C. 120, also incorporated by reference.

### BACKGROUND

The present disclosure generally relates to devices for welding workpieces, and more particularly to a laser device used for forming an annular circumferential weld on the workpieces.

Fusing two pieces of workpieces together by using a laser beam is well known in the art. Conventional laser welding systems create a precise bond by emitting a dense photon beam that melts targeted areas of the workpieces for bonding. A light ray of the laser beam instantly heats up the targeted areas so that the two pieces fuse together into one unit. Such laser welding systems provide a continuous beam for fusing thicker materials, or pulsing bursts of beams for binding thinner materials.

The light ray of a conventional laser beam is small and focused. Accordingly, such welding systems produce precise welds at a high volume required by production lines. For this reason, the welding industry has utilized lasers for their speed, accuracy and power. However, conventional laser beams typically have a linear trajectory, and are not readily bendable for redirecting the light rays. Thus, depending on the geometry of each targeted area, reaching some of the targeted areas can be a complicated task, especially for cylindrical or tubular workpieces that include rounded or curved regions on their circumferential surfaces.

Conventionally, as an example, to achieve a 360° (or degree) circumferential weld around the tubular workpiece, a laser head emitting the laser beam is transversely rotated around a longitudinal axis of the tubular workpiece by a rotating device. Another option is that the tubular workpiece is mounted angularly to a rotatable shaft so that when the shaft is rotated, the outer circumferential surfaces of the workpiece face the laser head for welding. Employing such rotational movement of the laser head and/or the workpieces complicates the production lines, and further requires more space than necessary for the rotating device and the rotatable shaft.

As an example, the tubular workpiece can be disposed longitudinally at a center of a concave circular mirror surrounding the workpiece. Then, the laser beam is swiveled or circled around the mirror above the workpiece, directing the laser beam around the entire circumferential outer surface of the workpiece. This conventional technique is not suitable in a manufacturing environment because manipulation of the workpiece through the center of the circular mirror is very difficult and burdensome in a high production setting.

As another alternative, a complex set of optical reflectors are used to redirect the laser beam on an opposite side of the workpiece. A combination of multiple concave and flat mirrors, such as conical, spherical, and plane mirrors, is used for deflecting the laser beam toward the opposite and lateral sides of the workpiece during welding. However, such intricate and convoluted optical systems are very expensive and difficult to repair during maintenance.

Therefore, there is a need for improving laser welding systems that facilitate simpler, more space-saving techniques, and for accommodating irregularly shaped workpieces during welding in a cost-effective way.

### SUMMARY

The present disclosure is directed to a laser device configured for forming an annular circumferential weld on a workpiece using a set of optical reflectors. The present laser device is designed to accommodate an irregularly shaped workpiece having rounded or curved outer surfaces. As described in further detail below, the present laser device welds the irregularly shaped workpiece without rotating or moving the workpiece or the laser head. A single laser beam is used to accomplish a complete 360° circumferential weld around the workpiece by placing at least two optical reflectors adjacent the workpiece at a predetermined angle.

One aspect of the present laser device is that the laser beam travels laterally along a path transverse to the longitudinal axis of the workpiece being welded. No rotational movement of the laser head is required for the welding. Specifically, as the laser beam moves along its linear path, the light ray is progressively reflected around the workpiece by the angled optical reflectors. As a result, the workpiece remains in a stationary position without having to change its location relative to the laser beam. In one embodiment, this simplified linear scan of the laser beam produces a complete circumferential weld on a variety of thermoplastic tubular assemblies in medical devices without requiring rotation of the workpiece.

Another important aspect is that the present laser device requires less space than conventional laser systems that rotate the laser head and/or the workpiece. In one embodiment, the laser head is disposed directly above the workpiece for reciprocating the laser beam transverse to the longitudinal axis of the workpiece. The present configuration requires less space and complexity between the laser head and the workpiece than conventional laser welding systems, thereby reducing disturbance caused by the rotating elements around the laser head and the workpiece during welding.

Yet another aspect of the present device is that at least two optical reflectors are provided for redirecting the laser beam, where each reflector includes a planar reflective surface for deflecting the laser beam onto an opposite side of the workpiece relative to the laser head. Standard flat optical reflectors are broadly available at a lower cost than the complex concave reflectors, and can be used for achieving an annular weld on the circumferential surface of the workpiece.

In one embodiment, a laser device is provided for performing an annular circumferential welding on a workpiece, and includes a laser head having a laser source configured for emitting a laser beam to perform welding around an outer circumferential target area of the workpiece. Also included is an optical reflector assembly having at least two optical reflectors spaced from the workpiece for reflecting the laser beam emitted from the laser head. The reflectors are spaced from each other, disposed on opposite lateral sides of the workpiece, and inclined relative to an axis transverse to a longitudinal axis of the workpiece so that the circumferential weld is achieved by a single cycle of the laser beam.

### BRIEF DESCRIPTION OF THE DRAWINGS

FIG. 1 is a top perspective view of the present laser device featuring an optical reflector assembly; and

FIG. 2 is a schematic front view of the present laser device using two optical reflector assemblies for simultaneous welding of two workpieces.

### DETAILED DESCRIPTION

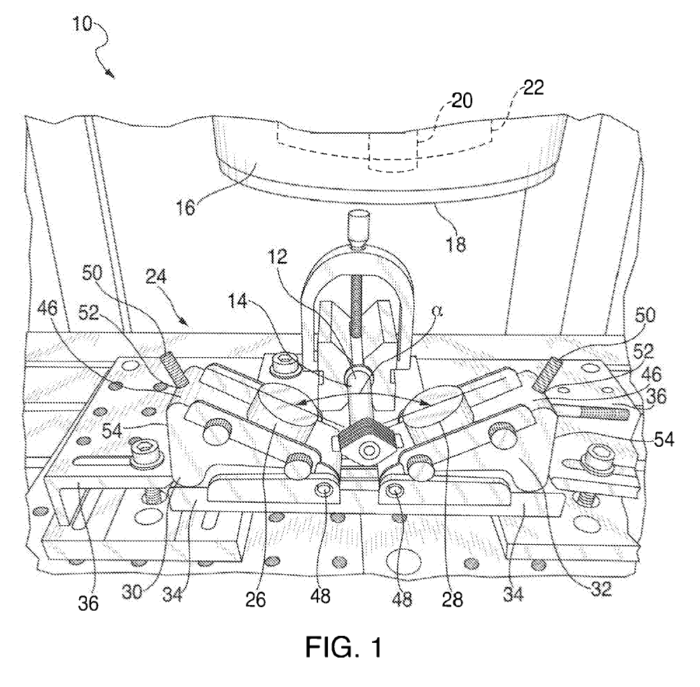

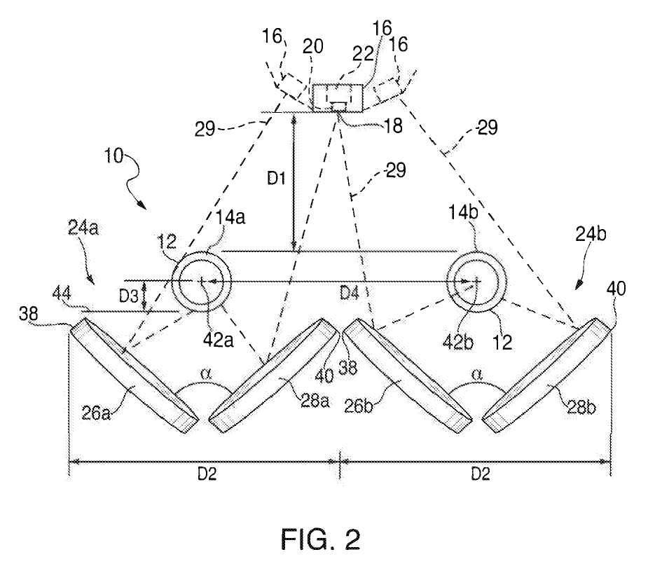

Referring now to FIGS. 1 and 2, the present laser device is generally designated 10 and is designed for achieving a 360° annular weld on a circumferential surface 12 of an irregularly shaped workpiece 14. It is contemplated that the circumferential surface 12 includes not only rounded or curved profiles, but also planar or irregular exteriors. Included in the device 10 is a laser head or laser scan head 16 having an opening 18 dimensioned and configured for emitting a laser beam from a laser source 20 (shown hidden) for welding. An exemplary laser source 20 includes a 2 micron Thulium laser, and an exemplary laser scan head 16 includes a 2-axis laser scan head. Other types of lasers are contemplated. It should be understood that the drawings are not necessarily to scale, and are intended for the purpose of illustrating a preferred embodiment of the present laser device 10.

The laser source 20 is kinematically connected to a reciprocating or rotating motion mechanism 22 (shown hidden) for moving the laser beam in a reciprocating or pivoting motion relative to the workpiece 14. It is preferred that the laser head 16 is connected to a frame (not shown) for holding the laser head vertically above the workpiece 14 such that the laser head 16 is adjustably movable along the frame relative to the workpiece. It is also contemplated that the laser source 20 can be inserted in the horizontal direction into the laser head 16 that is disposed directly above the workpiece 14. In the laser head 16 is a set of two deflecting mirrors (not shown) that can then direct the laser beam vertically downwardly onto a work area, and cause the laser beam to pivot about an axis at the mirrors to sweep back and forth across the workpiece 14. As an alternative, in a production environment for example, the laser source 20 is optionally movable laterally back and forth along the frame relative to the workpiece 14.

In a preferred embodiment, the present laser device 10 is placed into a larger laser machine (not shown), and the workpiece 14 is disposed on the device. As described in greater detail below, it is preferred that operational processes of the present laser device 10 are inputted into computer software as functional steps or modules. When the laser machine is powered on, the software causes the laser beam to move back and forth at a predetermined focal length that causes the laser beam to go out of focus at the work area.

The laser head 16 causes the laser beam to travel laterally along a path transverse to the longitudinal axis of the workpiece 14 being welded. One or more cycles of laser beam scanning is needed for adequate or effective welding on the workpiece 14, depending on the types of materials used in the workpiece. For example, up to 37 cycles of laser beam scanning may be required at a 2.75 second/pass using the 2 micron Thulium laser. The cycle refers to a continuous movement of the laser beam from an initial starting point to a traveling limit of the path transverse to the longitudinal axis of the workpiece 14 being welded, and back to the starting point.

An important aspect of the present laser device 10 is that only one laser beam is used to accomplish a complete 360° circumferential weld around the workpiece 14. More specifically, at least one optical reflector assembly, generally designated 24, is provided for deflecting the single laser beam emitted from the laser head 16 by placing at least one left optical reflector 26 and at least one right optical reflector 28, both of which are disposed on opposite lateral sides of the workpiece 14 at a predetermined angle α relative to an axis transverse to a longitudinal axis of the workpiece. An exemplary angle α is approximately 110°, and an exemplary optical reflector includes a gold plated mirror.

As the laser beam pivots about the axis at the mirrors in the laser head 16, and sweeps back and forth across the workpiece 14, the laser beam is progressively reflected around the workpiece 14 by the angled optical reflectors 26, 28. As a result, the complete 360° annular weld is achieved on the circumferential surface 12 of the workpiece 14 while the workpiece, the laser head 16 and the angled reflectors 26, 28 remain in a stationary position. As best shown in the FIG. 2 embodiment, for example, the laser head 16 in phantom lines schematically illustrates the pivoting movement of the laser beam 29 across the workpieces 14a, 14b for achieving the 360° annular weld.

Another important aspect of the present laser device 10 is that the laser head 16 is positioned from the workpiece 14 at a predetermined distance such that the laser beam is unfocused or out of focus for welding. Conventionally, the laser beam needs to be focused on the workpiece 14 with a constant laser path length. However, the present laser device 10 performs adequate welding on the workpiece 14 when the laser beam is out of focus on the circumferential surface 12 of the workpiece. An exemplary distance D1 (FIG. 2) between a focusing lens and the workpiece 14 is approximately 355 mm (or millimeters), but an exemplary focal length of the laser beam is set by the focusing lens to 260 mm to achieve the out of focus effect. In other words, the laser beam is travelling beyond the focal length set by the focusing lens before the laser beam contacts the workpiece 14, and this length of the laser beam may slightly vary depending on the path of the laser beam before contacting the workpiece. Furthermore, the variation of the length of the laser beam before the beam contacts the workpiece 14 will depend on whether the beam is directly contacting the workpiece 14 or reflecting off one of the angled reflectors 26, 28.

During welding, the laser beam emitted from the laser head 16 penetrates the circumferential surface 12 of the workpiece 14, heats targeted areas of the workpiece, and melts the targeted areas for bonding. More specifically, the laser beam is delivered to the circumferential surface 12 unfocused such that the targeted areas of the workpiece 14 are controlled based on the distance D1 between the focusing lens and the workpiece. This unfocused laser beam is useful for creating a larger targeted melting or heating area, and lowering an actual energy consumed for the welding. This unfocused or out of focus configuration is preferred because it broadens an affected area being heated by the laser beam so that the affected area creates an adequate bond and pathways on the workpiece 14 without heating the polymer material of the workpiece too aggressively.

To provide horizontal adjustability of the optical reflectors 26, 28, two adjustable brackets 30, 32 are provided in the optical reflector assembly 24 for accommodating the corresponding reflectors, and are part of a laser welding table 34 for slidably moving the brackets along a support rail 36. Both brackets 30, 32 are positioned on opposite lateral sides of the workpiece 14, and are symmetrically equally spaced from the longitudinal axis of the workpiece at a predetermined distance D2. An exemplary distance D2 from a leftmost edge 38 of the first reflector 26 and a rightmost edge 40 of the second reflector 28 edge relative to a longitudinal axis of the support rail 36 is approximately 45 millimeters. Further, an axial center 42 of the workpiece 14 is positioned from a top edge 44 of the first reflector 26 at a predetermined distance D3 relative to a vertical axis transverse to the longitudinal axis of the workpiece 14. An exemplary distance D3 is approximately 5 millimeters.

While other orientations are contemplated, it is preferred that the present laser device 10 is configured for positioning the reflectors 26, 28 in an arrangement such that each reflector is inclined at the predetermined angle α relative to the support rail 36, and is also inclined relative to a longitudinal axis of the laser beam. It is also contemplated that the spacing of the brackets 30, 32 relative to the workpiece 14 are variable to suit the situation, e.g., depending on a thickness of the workpiece.

Further included in the reflector assembly 24 is a liftable or inclinable plate 46 attached to the corresponding bracket 30, 32 via a pivot pin 48 for pivotally adjusting the corresponding reflector 26, 28 relative to the longitudinal axis of the support rail 36. Specifically, the inclinable plate 46 pivots radially about the pivot pin 48 to be selectively positioned at the predetermined angle α relative to the support rail 36 such that the entire outer circumferential surface 12 of the workpiece 14 is treated by the deflected laser beam in a progressive manner.

In a preferred embodiment, such pivotal adjustment of the plate 46 is controlled by rotating a transverse threaded fastener 50 through a slot 52 disposed on a side wall 54 of the bracket 30, 32 and against a top end of the plate 46. Although a tiltable bracket is shown for illustration purposes, other types of brackets are also contemplated for adjusting an angular disposition of the plate 46. As an example, a “C”-shaped bracket having an angle-adjusting fastener can be used in other applications. It is also contemplated that a slope adjustment of the plate 46 is achieved by fastening or unfastening the angle-adjusting fastener.

Referring now to FIG. 2, in another embodiment, simultaneous welding of two or more workpieces 14a, 14b is achieved by arranging two or more reflector assemblies 24a, 24b. In a preferred embodiment, the first two reflectors 26a, 28a are positioned to provide a first annular weld for a first workpiece 14a, and the other two reflectors 26b, 28b are similarly positioned to provide a second annular weld for a second workpiece 14b. An exemplary distance D4 between the axial centers 42a, 42b of the corresponding workpieces 14a, 14b is approximately 50 millimeters. Although two sets of reflector assemblies 24a, 24b are shown in FIG. 2 for illustration purposes, other variants of the reflector assemblies are also contemplated to suit the situation.

For example, in a manufacturing production line, an arrangement of multiple pairs of reflector assemblies is especially helpful when there are multiple workpieces requiring sealing or welding on a medical fluid container, such as an intravenous or medicinal bag. Because multiple pairs of reflector assemblies are juxtaposed and used for the welding or fusing of multiple sites simultaneously without having to rotate or move the workpieces 14 or the laser head 16, a manufacturing cycle time is reduced, and thus more workpieces can be processed during a given production period.

While other suitable configurations are contemplated, an exemplary configuration of the present laser device 10 includes an IPG Photonics® Mid-IR Microwelder System having a SCANcube 10 scan head with a set of two deflecting mirrors. The SCANcube 10 may be combined with a 260 mm focal length F-theta focusing lens within a Class 1 laser safety enclosure. Further included in the Microwelder System is a 120 Watt Thulium Fiber Laser module P/N TLM-120-1940-WC having a 1940 emission wavelength, randomly polarized, and a 5 meter feed fiber to 5 mm beam dia. Collimator for creating a target spot. Computer software, WinLase (Marking Software) Ver. 5.1.5.30 is provided for the Microwelder System. Edmund Optics are the optical reflectors 26a, 26b, 28a, 28b with Mirror Alum Plano 25.4 mm dia Gold P/N 47117.

More specifically, the two deflecting mirrors are provided to redirect the laser beam in the X-Y directions and to focus the beam onto the workpiece 14. This laser beam deflection task is performed by the two deflecting mirrors. For example, the laser source 20 emits the laser beam in a horizontal direction, and then the SCANcube 10 having the two deflecting mirrors redirects the laser beam from a horizontal path (Y direction) to a vertical path (X direction). By tilting the first and second deflecting mirrors, the laser beam entering the SCANcube 10 is deflected in the Y direction by the first mirror, and then the laser beam is deflected in the X direction by the second mirror. The resulting defection angles can be adjusted by controlling the positions of associated galvanometer scanners.

The F-theta focusing lens sets the focal length of the laser beam and the degree by which the laser beam is unfocused is determined by the distance of the workpiece from the F-theta focusing lens relative to the focal length set by the F-theta lens. The distance that the laser beam travels in a lateral direction relative to the workpiece 14 is determined by the distance of the workpiece from the SCANcube 10. Other suitable types of beam expanders or variable focusing systems are also contemplated.

An exemplary configuration of the workpiece materials is provided in Table 1 below.

TABLE 1
Part, Material, and Joint Dimensions

| | ID | | OD | | Thickness | Length | |
|---|---|---|---|---|---|---|---|
| Part | [mm] | ± | [mm] | ± | [mm] | [mm] | ± |
| Medication | 4.60 | na | 6.65 | 0.05 | 1.03 | 22.10 | na |
| Port: 70% | | | | | | | |
| Polypropylene | | | | | | | |
| 30% EVA | | | | | | | |
| Port Tube: 70% | 6.22 | 0.10 | 7.87 | 0.10 | 0.83 | 50.00 | 0.50 |
| Polypropylene | | | | | | | |
| 30% SEBS | | | | | | | |

As shown in Table 1 above, the medication port consisting of 70% Polypropylene and 30% EVA can be slidably inserted into the port tube consisting of 70% Polypropylene and 30% SEBS, creating the workpiece 14 for the 360° circumferential weld around the tube. During welding, the laser beam emitted from the laser head 16 penetrates the circumferential surface 12 of the workpiece 14, heats targeted areas of the workpiece, and melts the targeted areas for bonding the port and tube together.

Returning now to FIG. 2, an exemplary parameters for the computer software include a Power setting at 96%, a Mark Speed setting at 630 mm/sec (i.e., speed of a single path between two ends of the angled), a Frequency setting at 0.5 Hz, a Pulse Width setting at 2000 μs, and a Mark Design setting at a Straight Line option with 50 mm. The Mark Design refers to a specific value being inputted into the computer software, indicating that at preset length from the mirrors in the SCANcube 10, the distance of a single path the laser beam will travel is 50 mm. In a preferred embodiment, an exemplary distance from the mirrors in the SCANcube 10 to produce the 50 mm travel is 255 mm, and an exemplary distance between the mirrors in the SCANcube 10 and the optical reflectors 26, 28 is approximately 420 mm. As the optical reflectors are placed at a distance of 420 mm or farther than the set length of 255 mm, the distance the laser beam travels in a single path is in fact 90 mm (i.e., D2*2) and the beam travels this path across the two pairs of optical reflectors 26, 28.

It is contemplated that attributes and parameters of the laser beams may vary to suit other applications depending on the workpiece materials. In a preferred embodiment, the computer software is linked to the present laser device 10 for controlling and monitoring the welding, and also for adjusting and modifying the attributes and parameters of the laser beams as desired.

While a particular embodiment of the present laser device has been shown and described, it will be appreciated by those skilled in the art that changes and modifications may be made thereto without departing from the present disclosure in its broader aspects.

1. A laser device for performing an annular circumferential welding on a workpiece, comprising:
a laser head having a laser source configured for emitting a laser beam to perform welding around an outer circumferential target area of the workpiece; and
an optical reflector assembly having at least two optical reflectors spaced from the workpiece for reflecting the laser beam emitted from the laser head, the reflectors being spaced from each other, disposed on opposite lateral sides of the workpiece, and inclined relative to an axis transverse to a longitudinal axis of the workpiece so that the circumferential weld is achieved by a single cycle of the laser beam.

2. The laser device of claim 1, wherein the laser head is positioned from the workpiece at a first predetermined distance such that the laser beam is unfocused on the outer circumferential target area of the workpiece during the welding.

3. The laser device of claim 1, wherein the laser beam emitted from the laser head is adjusted for broadening an affected area of the targeted area of the workpiece for melting or heating at a predetermined focal length that causes the laser beam to go out of focus at the targeted area.

4. The laser device of claim 1, wherein the workpiece and the reflectors remain in a stationary position while the outer circumferential target area of the workpiece is welded by the laser beam.

5. The laser device of claim 1, wherein at least two adjustable brackets are provided in the optical reflector assembly for accommodating lateral adjustability of the optical reflectors.

6. The laser device of claim 5, wherein the adjustable brackets are positioned on opposite lateral sides of the workpiece, and are symmetrically equally spaced from the longitudinal axis of the workpiece at a second predetermined distance.

7. The laser device of claim 1, wherein an axial center of the workpiece is positioned from a top edge of the corresponding reflector at a third predetermined distance relative to a vertical axis transverse to the longitudinal axis of the workpiece.

8. The laser device of claim 1, wherein the reflectors are inclined from each other at a predetermined angle relative to the axis transverse to the longitudinal axis of the workpiece.

9. The laser device of claim 1, wherein an inclinable plate is attached to the corresponding reflector for pivotally adjusting the corresponding reflector relative to the axis transverse to the longitudinal axis of the workpiece.

10. The laser device of claim 1, wherein axial centers of at least two workpieces are spaced at a fourth predetermined distance between at least two corresponding optical reflector assemblies for performing the welding of multiple sites of the workpieces simultaneously.

11. The laser device of claim 1, wherein the laser beam travels linearly reciprocally along the axis transverse to the longitudinal axis of the workpiece being welded.
